(19) United States
(12) Patent Application Publication
(10) Pub. No.: US 2015/0261862 A1
(43) Pub. Date: Sep. 17, 2015

(54) Search Space Reduction Using Approximate Results

(71) Applicants: Kaushal MITTAL, Dublin, CA (US); Mahendra Chavan, Pune (IN); Kurt Wihelm Deschler, Hudson, MA (US); Steven A. Kirk, Chelmsford, MA (US)

(72) Inventors: Kaushal MITTAL, Dublin, CA (US); Mahendra Chavan, Pune (IN); Kurt Wihelm Deschler, Hudson, MA (US); Steven A. Kirk, Chelmsford, MA (US)

(21) Appl. No.: 14/206,552

(22) Filed: Mar. 12, 2014

(51) Int. Cl. G06F 17/30

(52) U.S. Cl. CPC G06F 17/30864; G06F 17/30339

(57) ABSTRACT

Embodiments include systems, methods and computer-readable mediums for accelerating a database query containing multiple predicates connected conjunctively. The database system receives a database query on a table. The database query includes a first predicate and a second predicate connected conjunctively. The database system produces a search space that satisfies a pre-filter for the first predicate. The search space represents rows of the table that satisfy the first predicate. The database system then applies the search space to evaluation of the second predicate. In one embodiment, the first predicate is a LIKE predicate requesting rows matching a search string in a column, and the pre-filter is a word index representing rows of the table containing a token of the search string in the column.

### BACKGROUND

Databases commonly organize data in the form of tables, each table having a number of rows and columns. Each row in a table generally has a data value associated with each of the columns. This intersection of rows and columns is commonly called a cell. A system needing access to data in the database typically issues a request in the form of a query. A query usually involves a request for the data contained in one or more cells of any rows which satisfy a set of predicates. A set of predicates can be combined using typical Boolean combining operators (e.g., AND, OR, and NOT), and these combinations can be arbitrarily nested within each other.

Some database systems are optimized to execute predicates in queries before executing any of the query operators. The result of a predicate, often termed a foundset, is a bitmap that represents a bit for each row of the table. A value of 1 for the bit indicates that the corresponding row satisfied the predicate whereas a value of 0 indicates that the corresponding row did not satisfy the predicate.

Evaluation of a predicate often involves the comparison of the values of cells in a column to some other value to determine whether the row associated with the compared cell satisfies the predicate. A direct comparison of each cell of interest in a table to a value is often computationally expensive, and database developers have accordingly introduced means by which rows satisfying a comparison operation can be more readily determined without the need to traverse every row of a table. A common optimization involves the use of a tree-based index structure to determine which rows contain a desired value. Each node of the tree represents a distinct value appearing within a particular column in any row of the table. Each node of the tree connects to a data structure representing the set of all rows in the table where the indexed column contains the specified distinct value. One such data structure that can be used to represent a set of rows is a bitmap, where each bit with a 1 value within the bitmap corresponds to a row containing the specified distinct value.

Some database systems use the index technique as a pre-filer to optimize the evaluation of a predicate. An index is a copy of select columns of data from a table that can be searched very efficiently. In some embodiments, computing an index results in a bitmap that identifies rows in a database table for which a particular column of that row (i.e., a cell) contains the requested value. One example of the index is the word index. A word index is used for indexing words (i.e., tokens) within a search string for fast lookup. For example, if a LIKE predicate is conditioned on “% Company1” as the search string, the database system can compute a word index on the token “Company1” of the search string. The result of the word index can be a bitmap representing all rows containing the token “Company1” in the search string. The database system can optimize the evaluation of a LIKE predicate in two phases. In the first phase, the database system takes the advantage of the word index to perform pre-filtering inexpensively before actually executing the LIKE predicate. The database system inexpensively computes an approximate foundset (e.g., the pre-filtered bitmap) by using the word index. The approximate foundset is “approximate” because the approximate foundset might contain false positives (i.e., rows that do not satisfy the LIKE predicate). In the second phase, the database system then executes the LIKE predicate by using the pre-filtered bitmap as its search space (i.e., the LIKE predicate is executed only on the rows qualified in the first phase). This reduces the cost of the second phase significantly because the second phase does not have to evaluate the predicate on already disqualified rows during the first phase.

If a LIKE predicate lies in a conjunctive tree (e.g., a set of predicates connected by one or more AND operators), then evaluation of other predicates in the conjunctive tree do not benefit from the pre-filtering technique described above. Instead, the database system continues to evaluate these other predicates in the conjunctive tree on the entire columns.

### BRIEF DESCRIPTION OF THE DRAWINGS

The accompanying drawings, which are incorporated herein and form a part of the specification, illustrate embodiments and, together with the description, further serve to explain the principles of the disclosure and to enable a person skilled in the relevant art to make and use the embodiments.

FIG. 1 illustrates a database network in which embodiments are implemented.

FIG. 2 illustrates an exemplary conjunctive tree 200 for two simple predicates and one complex predicate.

FIG. 3 is a flowchart of method 300 illustrating steps by which the approximate foundset of a pre-filter are used to restrict evaluation of other predicates in the same conjunctive tree, according to an embodiment.

FIG. 4 is a flowchart of method 400 illustrating steps by which a BETWEEN condition can help create a pre-filter bitmap to restrict evaluation of other predicates in the same conjunctive tree as the BETWEEN condition, according to an embodiment.

FIG. 5 is a flowchart of method 500 illustrating steps by which multiple pre-filters are combined to restrict evaluation of other predicates in the same conjunctive tree, according to one embodiment.

FIG. 6 depicts an example computer system in which embodiments may be implemented.

Embodiments will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

The accompanying drawings, which are incorporated herein and form part of the specification, illustrate the disclosed embodiments and, together with the description, further serve to explain the principles of the embodiments and to enable a person skilled in the pertinent art to make and use the embodiments. Various embodiments are described below with reference to the drawings, wherein like reference numerals are used to refer to like elements throughout.

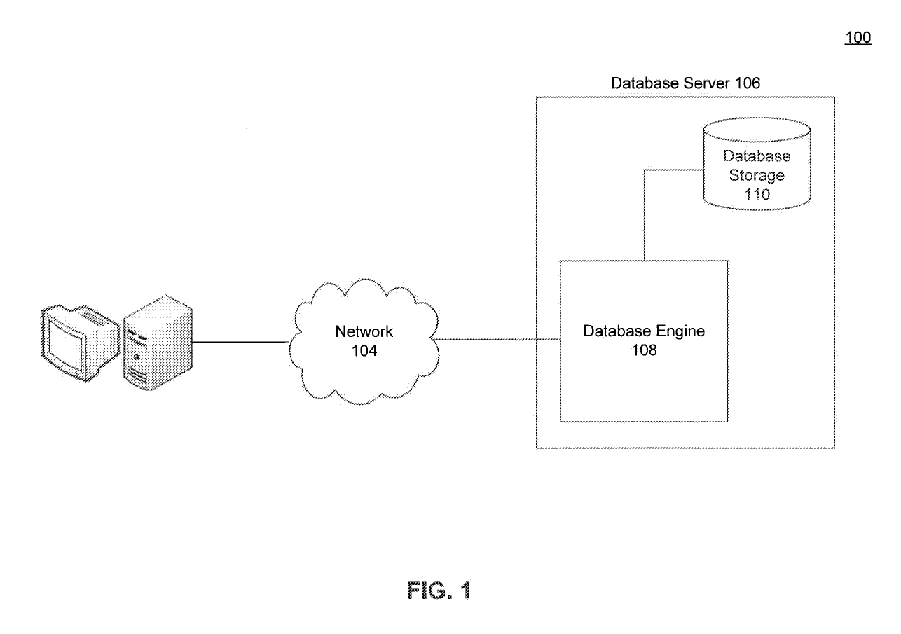

FIG. 1 depicts a database network 100 in which embodiments are implemented. The database network 100 includes a client system 102, a network 104, and a database server 106. The database server 106 includes a database engine 108 and database storage 110.

Client system 102 is operable to send a request for data, commonly in the form of a database query, to database server 106 over network 104. Database server 106 replies to the request by sending a set of results, commonly in the form of result rows from a database table, to client system 102 over network 104. One skilled in the relevant arts will appreciate that any data format operable to convey a request for data and a reply to the request may be used. In accordance with an embodiment, the requests and replies are consistent with the conventions used in the Structured Query Language (“SQL”), although this example is provided solely for purposes of illustration and not limitation.

Network 104 is optionally either a public or private communications network. In accordance with an embodiment, network 104 is the Internet. In accordance with an additional embodiment, network 104 is a private intranet, such as a corporate network. Network 104 can be any other form of wired or wireless network.

When a request for data, such as a query, is received by database server 106, it is handled by database engine 108, in accordance with an embodiment. Database engine 108 is operable to determine the data requested by the query, obtain the data, and provide a reply to the query. One skilled in the relevant arts will appreciate that while database engine 108 is illustrated as a single module in database network 100, database engine 108 may be implemented in a number of ways in order to accomplish the same function, including separating each of the aforementioned operations performed by database engine 108 into individual modules. Accordingly, the illustration of modules in database server 106 is not a limitation on the implementation of database server 106.

Database engine 108 is operable to obtain the data in response to the query from database storage 110, in accordance with an embodiment. Database storage 110 stores values of a database in a data structure. In accordance with an embodiment, database values are stored in a table data structure, the table having data rows and columns. At the intersection of each row and column is a data cell, the data cell having access to a data value corresponding to the associated row and column. Each column, in accordance with an embodiment, has an associated data type, such as “string” or “integer,” which is used by database engine 108 and client system 102 to interpret data contained in a data cell corresponding to the column. In accordance with an embodiment, the database comprises multiple tables.

Additionally, database storage 110 comprises alternate means of indexing data (e.g., bitmap) stored in a table of a database, in accordance with an embodiment. Database engine 108 is operable to analyze a query to determine whether an available alternate means is useful to optimally access the data stored in a table, and then depending on the result of the analysis utilizes this alternate means to obtain data from the table, in accordance with an embodiment. The embodiment includes using such an alternate means of indexing data stored in a database table, although one skilled in the relevant arts will appreciate that alternate means of invoking the algorithms disclosed herein in order to access data within a database are within the scope of the disclosure.

Database engine 108 can reduce the cost of evaluating a set of predicates in the same conjunctive tree. In one embodiment, database engine 108 identifies all opportunities where database engine 108 can inexpensively compute approximate foundsets using the indexes and other metadata. Database engine 108 then uses the computed approximate foundsets to form a reduced search space to restrict the evaluation of all other predicates in the same conjunctive tree.

A predicate is a condition in a database query that evaluates to a TRUE or FALSE result. A predicate can be either a simple predicate or a complex predicate. A simple predicate is a predicate that involves only one condition without any AND or OR operators (e.g., t.col1<100). A complex predicate combines two or more simple predicates using AND or OR, operators (e.g., t.col1<100 AND t.col2>1000). Two predicates are connected conjunctively if the two predicates are connected by an AND operator.

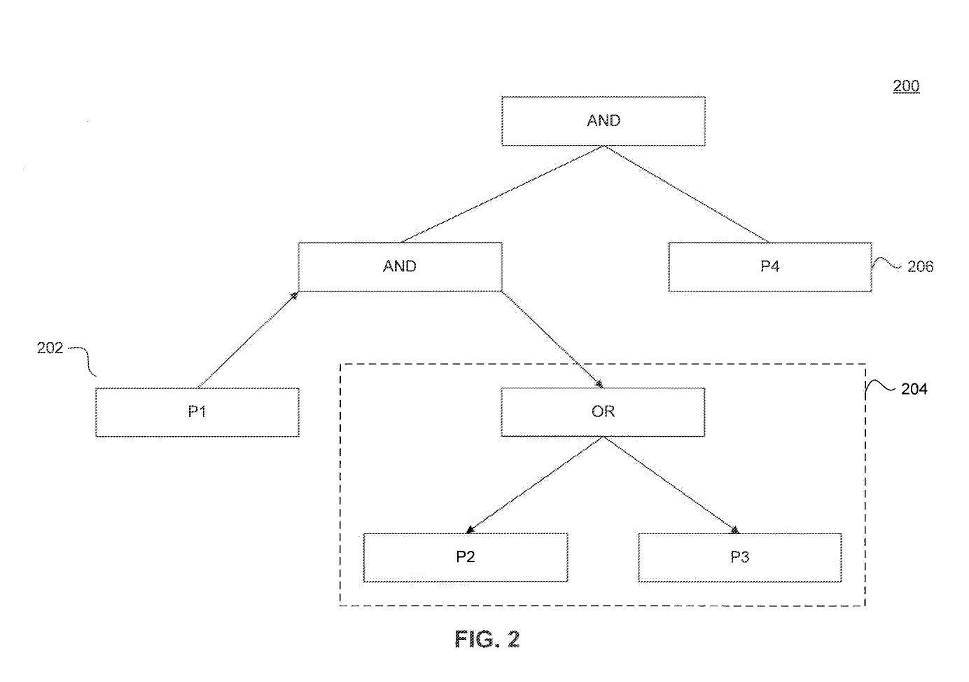

A predicate tree can represent a set of connected predicates. If the set of the predicates are all connected by AND operators, those predicates are in the same conjunctive tree. For example, FIG. 2 illustrates an exemplary conjunctive tree 200 for two simple predicates and one complex predicate.

Conjunctive tree 200 represents a set of predicates in the following WHERE clause in an SQL query.

WHERE P1 AND (P2 OR P3) AND P4

In FIG. 2, P1, P2, P3, and P4 each represents a simple predicate. As shown in FIG. 2, simple predicate 202 (P1), complex predicate 204 (P2 OR P3), and simple predicate 206 (P4) are all connected by AND operators. Therefore, simple predicate 202, complex predicate 204, and simple predicate 206 are in the same conjunctive tree. In this document, “predicates connected conjunctively” and “predicates in the same conjunctive tree” are used interchangeably.

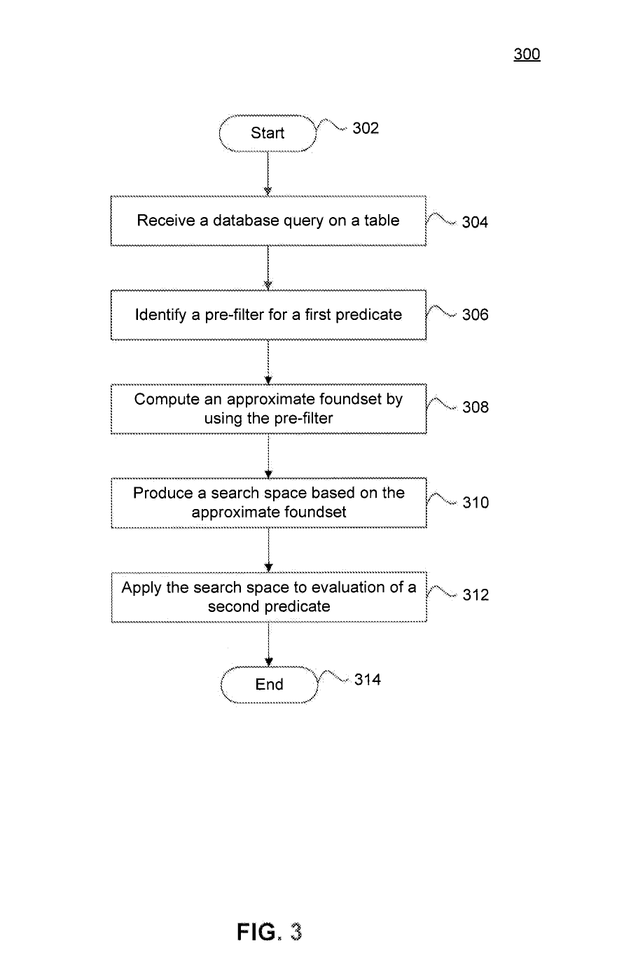

FIG. 3 is a flowchart of method 300 illustrating steps by which the approximate foundset of a pre-filter are used to restrict evaluation of other predicates in the same conjunctive tree, according to one embodiment. Method 300 shows one embodiment that takes advantages of the pre-filtering for one predicate to other predicates in the same conjunctive tree. It is to be appreciated that method 300 may not be executed in the order shown or require all operations shown. Method 300 can be performed by processing logic that can comprise hardware (e.g., circuitry, dedicated logic, programmable logic, microcode, etc.), software (e.g., instructions run on a processing device), or a combination thereof.

The method begins at step 302 and proceeds to step 304 where database engine 108 receives a database query on a table. At step 304, database engine 108 detects that the database query comprises a set of predicates and the predicates are connected conjunctively. As described above, a set of predicates are connected conjunctively if the predicates are connected by AND operators. As a purely illustrative example, the following expression shows three simple predicates connected conjunctively.

t.company LIKE ‘% COMPANY1’ AND t.employee_id=‘1234’ AND t.hiring_date=‘12/04/2011’ (1)

As another purely illustrative example, the following expression shows that a simple predicate (t.company=‘% COMPANY1’) is connected conjunctively to a complex predicate (t.employee_id=‘1234’ OR t.hiring_date=‘12/04/2011’).

t.company LIKE ‘% COMPANY1’ AND (t.employee_id=‘1234’ OR t.hiring_date=‘12/04/2011’) (2)

At step 306, database engine 108 identifies a pre-filter for a first predicate of the set of predicates. In one embodiment, the first predicate is a pre-filtering predicate. A pre-filtering predicate is any predicate in the set of predicates that can provide a pre-filter to restrict the search space for other predicates in the predicate set. In another embodiment, database engine 108 determines that a LIKE predicate can use a word index as the pre-filter. Those skilled in the relevant arts will appreciate that the first predicate does not have to be the first in position in the database query. Identifying the first predicate and its pre-filter depends on the type of predicate. Therefore, the first predicate can be the second, third, or even the last in position in the database query.

At step 308, database engine 108 computes an approximate foundset by using the pre-filter for the first predicate. Database engine 108 can also determine that the computation of an approximate foundset by using the pre-filter is faster than the evaluation of the corresponding first predicate. The computed approximate foundset represents a set of rows that are a superset of rows that satisfy the first predicate. The approximate foundset from computing the pre-filter includes all rows that satisfy the first predicate. In addition, the approximate foundset might contain false positives (i.e., rows that do not satisfy the first predicate).

In one embodiment, the predicate is a LIKE predicate and the pre-filter is a word index. For a purely illustrative purpose, example 1 discussed above shows a LIKE predicate conditioned on matching a search string in a column (e.g., t.company LIKE ‘% COMPANY1’). A search string often contains one or more wildcard characters (e.g., ‘% COMPANY1’). The index used as the pre-filter for the LIKE predicate is a word index. The approximate foundset computed based on the word index represents rows of the table containing a token of the search string in the column (e.g., ‘COMPANY1’). Consequently, the approximate foundset represents all rows that satisfy the LIKE predicate (e.g., all rows containing strings that end with ‘COMPANY1’ in the company column). However, the approximate foundset may also represent rows that are false-positives for the LIKE predicate (e.g., a row including “COMPANY1 Subsidiary” in the company column).

In one embodiment, the approximate foundset is a bitmap. The bitmap is an array of bits wherein each bit of the bitmap is associated with a row of a table. The individual bits of the bitmap are toggled between 0 and 1 to indicate whether or not a particular row satisfies the pre-filter condition, in accordance with an embodiment. For the purposes of example, a bit having a value of 0 is used to indicate that the pre-filter condition is not met for the corresponding row, and a bit having a value of 1 is used to indicate that the pre-filter condition is met for the corresponding row, but one skilled in the relevant arts will appreciate that the alternate condition or other convention may be used.

At step 310, database engine 108 produces a search space based on the approximate foundset. In one embodiment, the search space is the same bitmap as the approximate foundset. One skilled in the relevant arts will appreciate that the alternate data structure may be used.

At step 312, database engine 108 applies the search space to evaluation of a second predicate that is conjunctively connected to the first predicate. In one embodiment, applying the search space to evaluation of a second predicate means restricting the evaluation of the second predicate to the rows corresponding to the search space. For a purely illustrative purpose, if database engine 108 produces an approximate foundset corresponding to rows 3, 5, 7, and 8, based on the word index for the first predicate (t.company LIKE ‘% COMPANY1’) in example 1 discussed above, then database engine 108 can restrict evaluating the second predicate (t.employee_id=‘1234’) to rows 3, 5, 7, and 8 only. Evaluation of the second predicate is optimized by skipping evaluation of the second predicate for rows 1, 2, 4, 6, etc.

Example 1 provides an example that the second predicate immediately follows the first predicate in the database query. However, database engine 108 can apply the search space to any other predicate, as long as the predicate is conjunctively connected to the first predicate from which the search space is produced using a pre-filter. Therefore, the second predicate can precede the first predicate. Also, the second predicate does not need to be immediately connected to the first predicate. For a purely illustrative purpose, database engine 108 can also restrict evaluation of another predicate (t.hiring_date=‘12/04/2011’ in example 1) to rows 3, 5, 7, and 8. Yet in another embodiment, database engine 108 restricts evaluation of all predicates that are conjunctively connected to the first predicate to rows corresponding to the search space.

As discussed above, the second predicate can be a simple predicate or a complex predicate. Accordingly, in another embodiment, database engine 108 applies the search space to evaluation of a complex predicate, as long as the complex predicate is conjunctively connected to the first predicate (e.g., (t.employee_id=‘1234’ OR t.hiring_date===‘12/04/2011’) in example 2).

The method then ends at step 314.

The technique in method 300 uses a LIKE predicate and a corresponding word index as a non-limiting example. This technique can be also applied to use the approximate foundset produced by a positional text index to restrict evaluation of other predicates in the same conjunctive tree.

Some database systems employ a positional text index to help evaluate positional text conditions. A positional text condition requests rows matching a first term in a relative position to a second term in a column. These are typically either phrase conditions where a set of search terms must collectively appear in a precise order within a column cell value of the database, or a proximity condition where a set of search terms must appear within a specific distance of each other within a column cell value of the database, in order to satisfy the condition. For example, the positional text condition involving two terms, “International” and “Business,” may be of the form “International Business.” The positional text condition may also be the form of “International within 5 words of Business.” A positional text index can create a bitmap representing rows containing both the first term and the second term. For example, if positional text condition is the “International within 5 words of Business,” the positional text index can create a bitmap that represent rows containing both the first term “International” and the second term “Business” in the corresponding column.

At step 304, database engine 108 detects that the database query contains a positional text condition. The positional text condition requests rows matching a first term in a relative position to a second term in a column. At step 306, database engine 108 determines that a positional text index can serve as a pre-filter corresponding to the positional text condition. At step 308, database engine 108 can inexpensively compute an approximate foundset. According to one non-limiting embodiment, database engine 108 computes the approximate foundset by executing the positional text index. At step 312, this computed approximate foundset, usually a bitmap representing rows containing the first term and the second term, can then be applied to restrict evaluation of predicates that are conjunctively connected to the positional text condition.

Method 300 also applies to a set of predicates conjunctively connected to a predicate on DATE columns. Some database systems employ a date index to help evaluating predicates on DATE columns. A date index can be created on a column having the DATE type. The date index can create a bitmaps to track year, month, or date ranges. For example, a date index on the year value of 2014 creates a bitmap representing all rows in which the DATE column has the value 2014 in the year portion.

At step 304, database engine 108 detects that the database query contains a predicate on the DATE column. At step 306, database engine 108 determines that a date index can serve as a pre-filter corresponding to the predicate on the DATE column. At step 308, database engine 108 inexpensively computes an approximate foundset. According to one non-limiting embodiment, database engine 108 computes the approximate foundset by executing a date index on the year part of the predicate on the DATE column against the date index on the DATE column. At step 312, this computed approximate foundset, usually a bitmap representing rows matching the year part of the predicate on the DATE column, can then be applied to restrict evaluation of predicates that are conjunctively connected to the predicate on the DATE column. It is to be appreciated that a date index on month or date ranges can also serve as pre-filters.

The technique in method 300 can also use metadata in a database to help construct a pre-filter. In some database systems, a database table includes multiple pages. Each page has a page header which describes the information about the page. For example, the page header can include a minimum value and a maximum value of all rows in the page for a column.

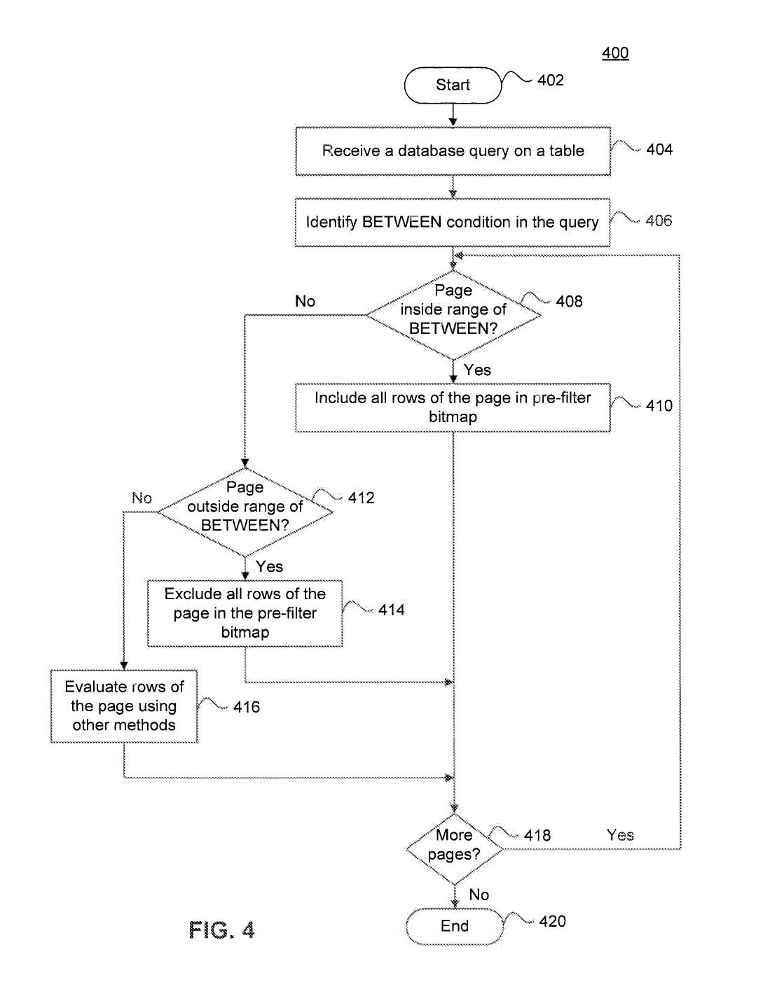

FIG. 4 is a flowchart of method 400 illustrating steps by which a BETWEEN condition can help create a pre-filter bitmap to restrict evaluation of other predicates in the same conjunctive tree as the BETWEEN condition. It is to be appreciated that method 400 may not be executed in the order shown or require all operations shown. Method 400 can be performed by processing logic that can comprise hardware (e.g., circuitry, dedicated logic, programmable logic, microcode, etc.), software (e.g., instructions run on a processing device), or a combination thereof.

The method starts at step 402 and proceeds to step 404. At step 404, database engine 108 receives a database query on a table. The query contains a set of predicates connected conjunctively. Database engine 108 identifies that one of the predicates is a BETWEEN condition. The BETWEEN condition requests rows inside a range in a column (e.g., t.x BETWEEN 1 and 10). Next, steps 408 to 418 are performed for each page of the table.

At step 408, database engine 108 determines, based on the page header information, whether the minimum value and the maximum value of the page fall inside the range indicated by the BETWEEN condition. If so, at step 410, database engine 108 includes all rows of the page in the pre-filter bitmap by setting all bits corresponding to all rows of the page to 1.

If the page does not fall inside the range indicated by the BETWEEN condition, at step 412, engine 108 determines, based on the page header information, whether the minimum value and the maximum value of the page fall outside the range indicated by the BETWEEN condition. If so, at step 414, database engine 108 excludes all rows of the page in the pre-filter bitmap by setting all bits corresponding to all rows of the page to 0.

If the minimum value and the maximum value of the page are neither inside nor outside the range indicated by the BETWEEN condition, database engine 108 examines the rows of the page by other method at step 416. In one embodiment, database engine 108 examines the rows of the page using a row-by-row evaluation. In another embodiment, database engine 108 examiners the rows of the page using the techniques described above.

At step 418, database engine 108 determines whether there are more pages to be examined. If so, steps 408-418 repeat for the next page. If there are no more pages to be examined, then method 400 ends at 420.

If database engine can identify multiple pre-filters in a database query, database engine 108 can combine those multiple pre-filters to further limit the search space for evaluating a set of predicates in the same conjunctive tree.

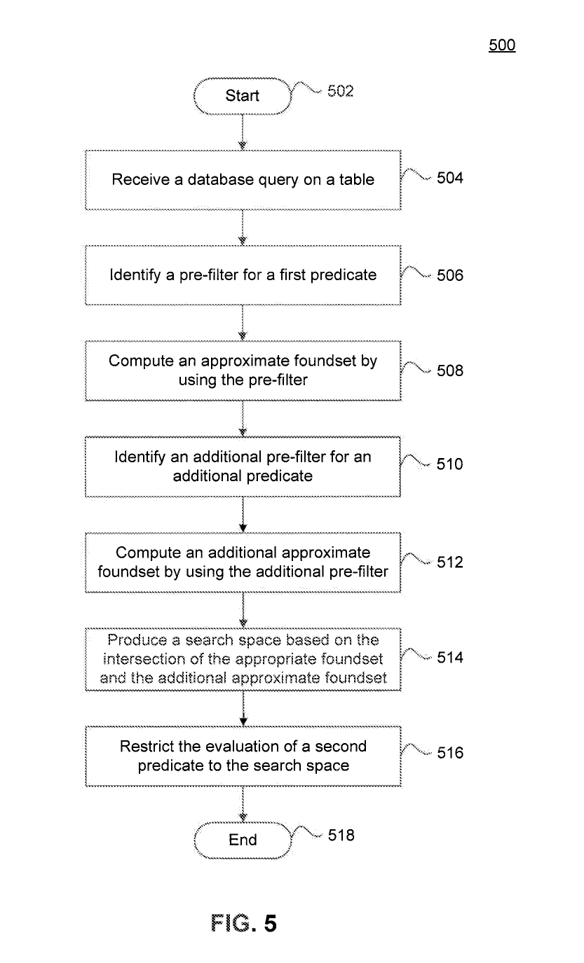

FIG. 5 is a flowchart of method 500 illustrating steps by which multiple pre-filters are combined to restrict evaluation of other predicates in the same conjunctive tree, according to one embodiment. It is to be appreciated that method 500 may not be executed in the order shown or require all operations shown. Method 500 can be performed by processing logic that can comprise hardware (e.g., circuitry, dedicated logic, programmable logic, microcode, etc.), software (e.g., instructions run on a processing device), or a combination thereof.

The method begins at step 502 and proceeds to step 504 where database engine 108 receives a database query on a table. At step 504, database engine 108 detects that the database query comprises a set of predicates and the predicates are connected conjunctively. At step 506, database engine 108 identifies a pre-filter for a first predicate of the set of conjunctively connected predicates. At step 508, database engine 108 computes an approximate foundset by using the pre-filter for the first predicate.

At step 510, database engine 108 identifies an additional pre-filter for an additional predicate in the set of conjunctively connected predicates. At step 512, database engine 108 computes an additional approximate foundset by using the additional pre-filter for the additional predicate.

At step 514, database engine 108 produces a search space based on the intersection of the approximate foundset and the additional approximate foundset. In one embodiment, database engine 108 first produces the search space based on the foundset. Then, database engine 108 modifies the search space by intersecting the approximate foundset and the additional approximate foundset.

At step 516, database engine 108 restricts evaluation of a second predicate to the rows corresponding to the search space (i.e., intersection of two approximate foundset) produced at step 514. In one embodiment, the search space is a bitmap representing the intersection of rows satisfying the pre-filter and the rows satisfying the additional pre-filter.

As a purely illustrative example, assume database engine 108 receives a database query containing the following three simple predicates connected conjunctively:

t.company LIKE ‘% COMPANY1’ AND t.employee_id ‘1234’ AND t.hiring_date=‘12/04/2011’

Database engine 108 first detects that database engine 108 can build an approximate foundset for the first predicate (t.company LIKE ‘% COMPANY1’) by using the word index as a pre-filter. Database engine 108 then detects that database engine 108 can build an additional approximate foundset for an additional predicate (t.hiring_date=‘12/04/2011’) by using the date index as an additional pre-filter. For example, if the first approximate foundset is a bitmap representing rows 1, 3, 4, 6, and 8 and the additional approximate foundset is a bitmap representing rows 2, 3, 4, 5, and 7, then the search space is an intersection of the two bitmaps. The intersection represents rows 3 and 4. Thus, database engine 108 can restrict evaluation of the second predicate (t.employee_id=‘1234’) to rows 3 and 4 only.

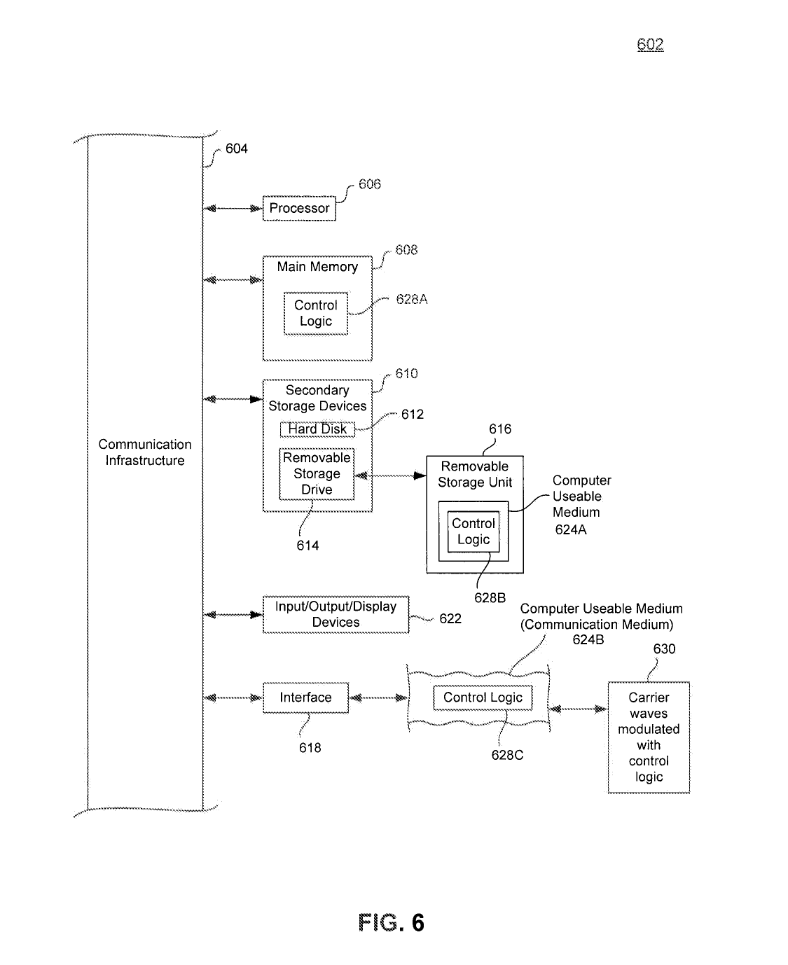

In an embodiment, the system and components of embodiments described herein are implemented using well known computers, such as computer 602 shown in FIG. 6. For example, database engine 108 or database engine 108 can be implemented using computer(s) 602.

The computer 602 can be any commercially available and well known computer capable of performing the functions described herein, such as computers available from International Business Machines, Apple, Sun, HP, Dell, Compaq, Digital, Cray, etc.

The computer 602 includes one or more processors (also called central processing units, or CPUs), such as a processor 606. The processor 606 is connected to a communication bus 604.

In this document, the terms “computer program medium,” “computer-usable medium,” “computer-readable device,” and “non-transitory computer-readable medium” are used to generally refer, but not limited to, tangible media such as main memory 608, hard disk drive 612, and removable storage drive 614.

The computer 602 also includes a main or primary memory 608, such as random access memory (RAM). The primary memory 608 has stored therein control logic 628A (computer software), and data.

The computer 602 also includes one or more secondary storage devices 610. The secondary storage devices 610 include, for example, a hard disk drive 612 and/or a removable storage device or drive 614, as well as other types of storage devices, such as memory cards and memory sticks. The removable storage drive 614 represents a floppy disk drive, a magnetic tape drive, a compact disk drive, an optical storage device, tape backup, etc.

The removable storage drive 614 interacts with a removable storage unit 616. The removable storage unit 616 includes a computer useable or readable storage medium 624 having stored therein computer software 628B (control logic) and/or data. Removable storage unit 616 represents a floppy disk, magnetic tape, compact disk, DVD, optical storage disk, or any other computer data storage device. The removable storage drive 614 reads from and/or writes to the removable storage unit 616 in a well-known manner.

The computer 602 also includes input/output/display devices 622, such as monitors, keyboards, pointing devices, etc.

The computer 602 further includes a communication or network interface 618. The network interface 618 enables the computer 602 to communicate with remote devices. For example, the network interface 618 allows the computer 602 to communicate over communication networks or mediums 624B (representing a form of a computer useable or readable medium), such as LANs, WANs, the Internet, etc. The network interface 618 may interface with remote sites or networks via wired or wireless connections.

Control logic 628C may be transmitted to and from the computer 602 via the communication medium 624B. More particularly, the computer 602 may receive and transmit carrier waves (electromagnetic signals) modulated with control logic 630 via the communication medium 624B.

Any apparatus or manufacture comprising a computer useable or readable medium having control logic (software) stored therein is referred to herein as a computer program product or program storage device. This includes, but is not limited to, the computer 602, the main memory 608, secondary storage devices 610, the removable storage unit 616 and the carrier waves modulated with control logic 630. Such computer program products, having control logic stored therein that, when executed by one or more data processing devices, cause such data processing devices to operate as described herein, represent embodiments.

Embodiments can work with software, hardware, and/or operating system implementations other than those described herein. Any software, hardware, and operating system implementations suitable for performing the functions described herein can be used.

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the embodiments and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the embodiments should not be limited by any of the above-described exemplary embodiments, but should be defined only in accordance with the following claims and their equivalents.

What is claimed is:

1. A method, comprising:
receiving a database query on a table, the query comprising a first predicate and a second predicate connected conjunctively;
producing a search space that satisfies a pre-filter for the first predicate, the search space comprising a representation of rows of the table that satisfies the first predicate; and
applying the search space to an evaluation of the second predicate,
wherein at least one of the receiving, producing, and applying is performed by one or more computers.

2. The method of claim 1, wherein applying the search space comprises:
restricting the evaluation of the second predicate to the search space.

3. The method of claim 1, wherein the pre-filter comprises an index.

4. The method of claim 3, wherein the first predicate comprises a LIKE predicate conditioned on matching a search string in a column, and wherein the index comprises a word index representing rows of the table containing a token of the search string in the column.

5. The method of claim 3, wherein the first predicate comprises a positional text condition conditioned on matching a first term in a relative position to a second term in a column, the pre-filter comprises a positional text index representing rows of the table containing both the first term and the second term in the column.

6. The method of claim 3, wherein the first predicate comprises a DATE predicate conditioned on matching a search date in a column, the pre-filter comprises date index representing rows of the table satisfying a year part of the search date in the column.

7. The method of claim 1, wherein the first predicate comprises a BETWEEN condition conditioned on being inside a range in a column, and the producing the search space comprises:
determining that a header of a page of the table indicates that a minimum value and a maximum value of the page fall inside the range in the column; and
including representation of all rows of the page in the search space.

8. The method of claim 1, wherein the first predicate comprises a BETWEEN condition conditioned on being inside a range in a column, and the producing the search space comprises:
determining that a header of a page of the table indicates that a minimum value and a maximum value of the page fall outside the range in the column; and
excluding representation of all rows of the page in the search space.

9. The method of claim 1, further comprising:
determining that the producing the search space is faster than the evaluation of the first predicate.

10. The method of claim 1, wherein the database query further comprises an additional predicate connected conjunctively to the first predicate and the second predicate, and wherein the applying comprises:
producing an additional search space that satisfies an additional pre-filter for the additional predicate, the additional search space including representation of rows that satisfies the additional predicate; and
restricting the evaluation of the second predicate to an intersection of the search space and the additional search space.

11. A database system, comprising:
a memory;
at least one processor coupled to the memory;
a database engine, implemented on the at least one processor, configured to perform operations comprising:
receiving a database query on a table, the query comprising a first predicate and a second predicate connected conjunctively;
producing a search space that satisfies a pre-filter for the first predicate, the search space comprising a representation of rows of the table that satisfies the first predicate; and
applying the search space to an evaluation of the second predicate.

12. The system of claim 11, wherein applying the search space comprises:
restricting the evaluation of the second predicate to the search space.

13. The system of claim 11, wherein the pre-filter comprises an index.

14. The system of claim 13, wherein the first predicate comprises a LIKE predicate conditioned on matching a search string in a column, and wherein the index comprises a word index representing rows of the table containing a token of the search string in the column.

15. The system of claim 13, wherein the first predicate comprises a positional text condition conditioned on matching a first term in a relative position to a second term in a column, the pre-filter comprises a positional text index representing rows of the table containing both the first term and the second term in the column.

16. The system of claim 13, wherein the first predicate comprises a DATE predicate conditioned on matching a search date in a column, the pre-filter comprises date index representing rows of the table satisfying a year part of the search date in the column.

17. The system of claim 11, wherein the first predicate comprises a BETWEEN condition conditioned on being inside a range in a column, and the producing the search space comprises:
determining that a header of a page of the table indicates that a minimum value and a maximum value of the page fall inside the range in the column; and
including representation of all rows of the page in the search space.

18. The system of claim 11, wherein the first predicate comprises a BETWEEN condition conditioned on being inside a range in a column, and the producing the search space comprises:
determining that a header of a page of the table indicates that a minimum value and a maximum value of the page fall outside the range in the column; and
excluding representation of all rows of the page in the search space.

19. The system of claim 11, the operations further comprising:
determining that the producing the search space is faster than the evaluation of the first predicate.

20. The system of claim 11, wherein the database query further comprises an additional predicate connected conjunctively to the first predicate and the second predicate, and wherein the applying comprises:
producing an additional search space that satisfies an additional pre-filter for the additional predicate, the additional search space including representation of rows that satisfies the additional predicate; and
restricting the evaluation of the second predicate to an intersection of the search space and the additional search space.

21. A non-transitory computer-readable medium having instructions stored thereon, execution of which, by a computing device, causes the computing device to perform operations comprising:
receiving a database query on a table, the query comprising a first predicate and a second predicate connected conjunctively;
producing a search space that satisfies a pre-filter for the first predicate, the search space comprising a representation of rows of the table that satisfies the first predicate; and
applying the search space to an evaluation of the second predicate.
